(19) United States
(12) Patent Application Publication
(10) Pub. No.: US 2009/0018814 A1
(43) Pub. Date: Jan. 15, 2009

(54) Method and system for providing projector images

(76) Inventor: Eric Johannus Nieuwlands, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/582,381

(22) PCT Filed: Dec. 8, 2004
(86) PCT No.: PCT/IB04/52714

§ 371 Date: Jun. 9, 2006

Related U.S. Application Data
(60) Provisional application No. 60/529,087, filed on Dec. 12, 2003.

(51) Int. Cl. G06F 9/455; G06F 17/00; G06F 3/048

(52) U.S. Cl. 703/24; 715/273; 715/748

(57) ABSTRACT

A computer program product in a computer readable medium having projector driver computer readable code for converting an application file into a projectable image file for presentation by a projector connected to a network. The computer program product further had a network interface computer readable code for communicating the projectable image file in the form of a printer file over the network to the projector to thereby facilitate a subsequent presentation of the projectable image file by the projector.

The technical field of this invention relates generally to projection type display devices and more specifically to projectors that simulate a printer connected to a computer or network of computers.

Projection type display devices, or projectors, are commonly used during meetings to present information to a large group of people. Typically, projectors project images onto a screen or other flat surface viewable by the audience. The images projected may be text, graphics or combinations of both.

In many projection systems, the images that are projected are stored in memory at a location external to the projector. For example, the image may be stored on a server or personal computer. Therefore, in order for the image to be viewed, the image must be retrieved from the server or personal computer. For these applications, the image is accessed by the projector via a network connection to the computer or server storing the image. One drawback to this arrangement is that the user must have access to the image. Difficulty may arise where the user does not have the proper access codes or passwords to access the image. Another drawback is that the system may not be easy to navigate during the retrieval process.

In other projection systems, the projector must include a viewer for the same software the image was produced with in order to display the image. This often is a disadvantage when the projector is being used by a number of people having a variety of word programs and graphics programs. A disadvantage also exists if the projector has a viewer that is outdated in relation to the program used to prepare the file to be projected.

For many, using a projector may be a rare occurrence, offering limited familiarity with the proper procedure for using the projector. For others who are not technically proficient, the use of a projector may be daunting, leaving them frustrated and unable to accomplish a task in an efficient manner.

It would be desirable, therefore, to provide a method and system for displaying digital images using a projector that overcomes these and other disadvantages.

One form of the present invention is a computer program product in a computer readable medium.

In one embodiment, the computer program product comprises (1) projector driver computer readable code for converting an application file into a projectable image file for presentation by a projector connected to a network, and (2) a network interface computer readable code for communicating the projectable image file in the form of a printer file over the network to the projector to thereby facilitate a subsequent presentation of the projectable image file by the projector.

In a second embodiment, the computer program product comprises (1) a project driver computer readable code for converting an application file to a projectable image file for presentation by a projector connected to a network, and (2) a graphical user interface computer readable code for displaying a printer listing including the projector to thereby facilitate a subsequent communication of the projectable image file in the form of a printer file from the computer over a network to the projector.

In a third embodiment, the computer program comprises (1) network interface computer readable code for communicating a projectable image file in the form of a printer file over a network to a projector, and (2) graphical user interface computer readable code for displaying a file listing including the projectable image file to thereby facilitate a subsequent presentation of the projectable image file by the projector.

The foregoing forms as well as other forms, features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

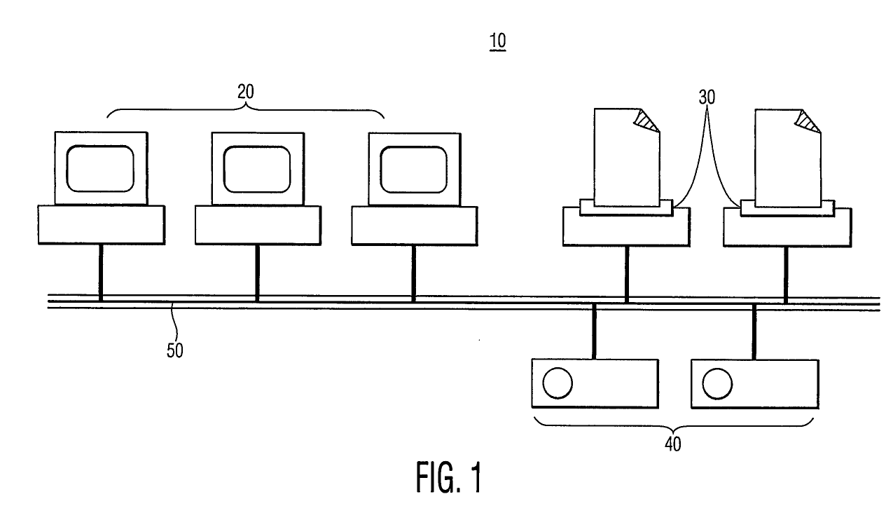

FIG. 1 illustrates a block diagram of one embodiment of a projection system in accordance with the present invention;

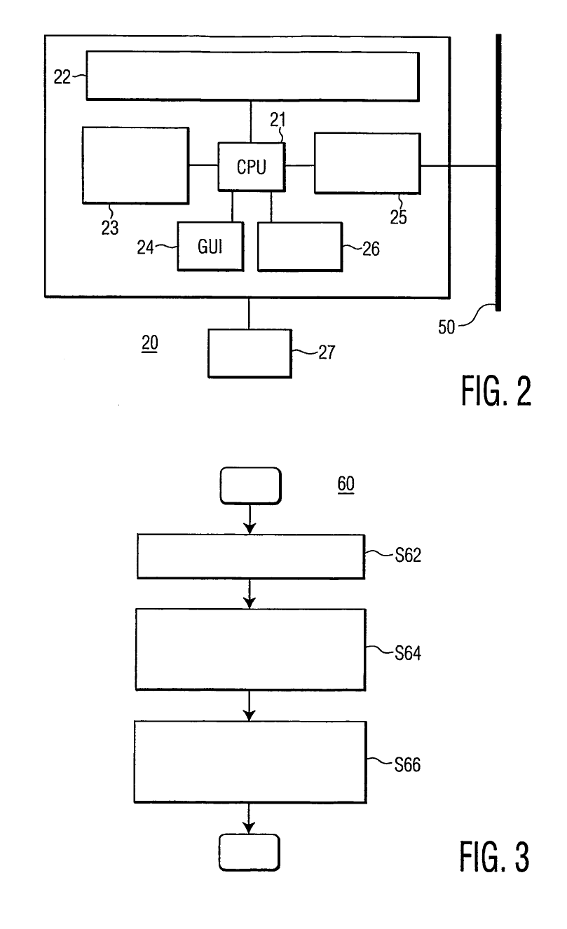

FIG. 2 illustrates a block diagram of one embodiment of a computer in accordance with the present invention;

FIG. 3 illustrates a flow diagram representative of one embodiment of a computer management method in accordance with the present invention;

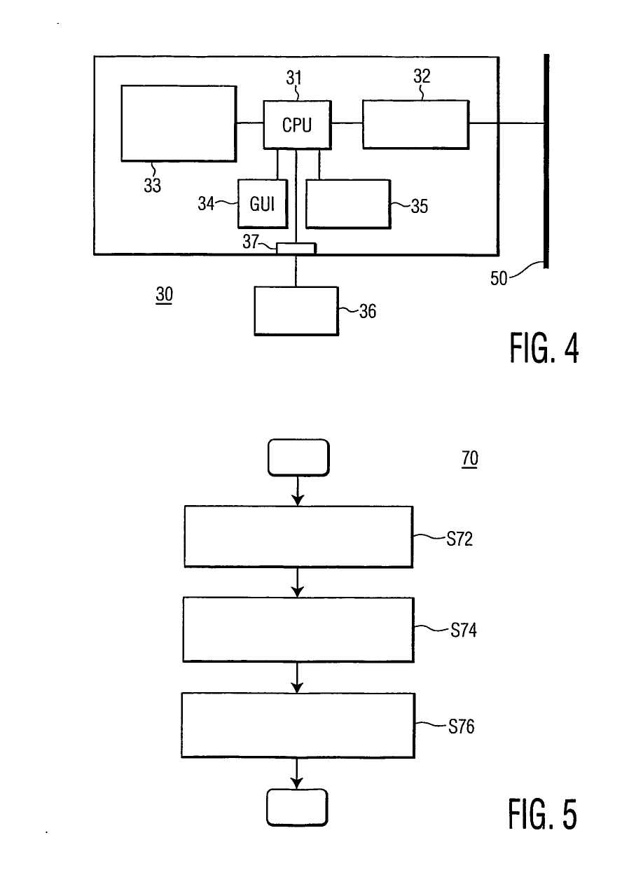

FIG. 4 illustrates a block diagram of one embodiment of a projector in accordance with the present invention; and

FIG. 5 illustrates a flow diagram representative of one embodiment of a projector management method in accordance with the present invention.

A projection system 10 as illustrated in FIG. 1 employs one or more personal computer (“PC”) 20, one or more printers 30, and one or more projectors 40, all of which are conventionally connected to a network 50.

Each PC 20 as best shown in FIG. 2 employs a CPU 21, at least one application program 22, a projector driver module 23, a graphical user interface (GUI) 24, network interface 25 and memory 26.

CPU 21 executes application program(s) 22. Application program(s) 22 are used to create an application file. Application program(s) 22 are well known in the art and include such programs as, for example, Microsoft® PowerPoint®, Microsoft® Visio®, and Microsoft® Word®. A user creates the application file via the graphical user interface 24 that is displayed on a monitor (not shown). The GUI is also used by the user to navigate through various other commands for saving and printing an application file as is well known in the art.

PC 20 also includes projector driver module 23. The projector driver module includes the software that enables the user to select the projector as a printer option in a manner similar to that of choosing a printer to print a document. In one embodiment, the projector is included in the list of available printers a user accesses through a GUI for selecting a printer. Upon installation of the projector driver software, the projector is selectable as a printer option in addition to any other printer that is connected to or networked with the PC. Additionally, the projector driver software converts an application file created by the user (graphic and/or text file) to a projectable image file to be sent to and saved on the projector. In one embodiment, the converted image files are compressed before they are saved and/or transmitted to the projector.

Network interface 25 provides the connection between the network and PC 20 and allows communication between PC 20 and various other components of system 10, such as, for example, a server, printer 30 and projector 40. The network interface 25 connection may be wired, wireless or a combination of both.

Memory 26 provides storage for application files created by the user or any other files the user wishes to store on PC 20.

PC 20 further includes at least one input device 27 that may be, for example a keyboard or a mouse. PC 20 also includes ROM, RAM, a hard disk drive and additional hardware and software well known to those with skill in the art necessary for executing application programs 22.

FIG. 3 illustrates a flow diagram representative of one embodiment of a computer management method 60 for preparing and transmitting a projectable application file. The method is implemented a computer program product stored within a computer readable medium of projector driver module 23 or within memory 26.

The method begins by displaying a list of printers available to the prepared application file (Step S62). The application file may be a graphical image file, a text document or a combination of both as is well known in the art. The graphic image or text document can be prepared using any application program 22 such as, for example, Microsoft® PowerPoint®, Microsoft® Visio®, Microsoft® Word®, or any other of a variety of programs well known to those with skill in the art. The application file may then be saved to the PC memory 26 or server memory (not shown) before continuing the method 60.

Once the application file has been prepared, the user then proceeds to “print” the file to the projector. In one embodiment, the user accesses the list of available printers and chooses the projector as the printer. In another embodiment, the projector may be installed as the default printer allowing the user to send the application file to the projector without having to choose the projector from a list of available printers. At this time, the user may provide properties to the application file, as one would do when sending a file to a printer. For example, the user can name the file, and select the quality, resolution and page orientation of the displayed image. The user may select from a variety of options similar or identical to that available when sending a document to a printer. This provides the user with a familiar interface, thereby making the user more efficient as well as eliminating the apprehension a user may experience when using a new device.

Next, the application file is converted into a projectable image file (Step S64). The application file is converted from the type of file it was created in, for example, a .ppt (PowerPoint®), .vsd (Visio®) or .doc (Microsoft Word®) to a projectable image file such as, for example, .pdf, .jpg, .tif, .gif, .png or .bmp files. The projector may include the software to retrieve and display one, some or all of these types of image files. The converted (projectable) file may be

saved to the server or PC before being transferred to projector 30. In one embodiment, the converted file is compressed before communicating the projectable file to the projector or saving the file.

In one embodiment, the projectable image file is saved on an external storage device such as, for example, a compact disk, floppy disk, memory card, or other portable storage medium known to those with skill in the art before it is communicated to the projector. This embodiment is useful in situations where the projector is not available via a network connection.

Next, the projectable image file is then communicated to the projector 30 (Step S66). The projectable image file is communicated to the projector via the network interface module 25 in the form of a printer file. The method for displaying the projectable image file communicated to the projector from the PC is provided in FIG. 5, below.

Each projector 30 as best shown in FIG. 4 employs a CPU 31, a network interface 32, a projection electronic module 33, and a graphical user interface 34. Projector 30 includes all software, hardware and combinations thereof necessary for displaying projectable images. Projector 30 includes software for selecting and displaying image files that have been saved as, for example, .jpg, .tiff or .bmp files. CPU 31 allows communication between PC 20 and projector 30 via network interface 32.

Memory 35 stores the projectable images transmitted to projector 30 via the network 50 or input device 36. In one embodiment, memory 35 is internal. In another embodiment, memory 35 is external to the projector, such as, for example, an external memory card provided by the user. Projectable image files stored on memory 35 may be managed in several ways. In one embodiment, the user may select a projectable image file to remove (i.e. delete) via the GUI. Once selected, the user chooses to delete the file in a manner well known in the art. In another embodiment, files are removed from memory upon the passing of a predetermined length of time. For example, a file may be removed automatically from memory one week after it was sent to the projector. The predetermined length of time may be days or weeks, and may depend on the use of the projector. In another embodiment, if the buffer memory is full, the oldest image files are removed as new files are sent to the projector.

Projector 30 is operably connected to input device 36. CPU 31 receives transmission of commands from input device 36 through an input/output port 37. Input device 36 may be a keyboard or a mouse. In one embodiment, input device 36 is a laptop computer. Input device 36 may be connected to projector 30 through a wired or wireless connection. In another embodiment, input/output port 37 is connected to a wireless input unit (not shown). The wireless input unit receives input data wirelessly transmitted from a wireless input device. In one embodiment, input device 36 is a wireless keyboard.

In one embodiment, projector 30 also includes a graphics user interface (GUI) 34. Graphics user interface 34 may be projected onto the same screen used to display the projected images or, in another embodiment, the GUI may be displayed on a monitor of a PC used as input device 36. The GUI provides the interface for the user to select the image to be displayed and to navigate through the selected images.

In one embodiment, projector 30 also includes at least one disc drive (not shown) for reading compact or floppy discs. The at least one disc drive is operably connected to CPU 31. In this embodiment, the projectable image to be displayed may be transferred to an internal storage medium of projector 30 before display or may be accessed directly by the CPU for display.

FIG. 5 shows a flow chart for one embodiment of a method 70 for displaying a projectable image. The method is implemented a computer program product stored within a computer readable medium of projector electronics module 33 or within memory 35.

The method 70 begins with the projector receiving and storing a projectable image file (Step S72). The projectable image may be received from PC 20 via network 50, as in Step S66 of method 60. Once received, the projectable image is stored in memory 35 of projector 30. In another embodiment, the projectable image file is transferred from an external storage medium to memory 35.

The stored projectable image file may then be selected for display by the user from a listing of available image files (Step S74). In one embodiment, the user accesses the file to be displayed using the graphical user interface 34 of projector 30. The graphical user interface (GUI) may display a list of image presentation files available for selection. The files may be listed by the name provided by the user. The GUI may be projected onto a screen provided for the projection of the image or, in another embodiment, the GUI may be displayed on a monitor that is associated with input device 36 such as, for example, a laptop computer.

Once selected, the chosen projectable image file may be presented (Step S76) and the presentation started. CPU 31 of projector 30 sends a control signal to memory 35 to access the selected image presentation file. In one embodiment, the control signal is sent to the external memory device to access the selected file. In another embodiment, the selected image file must be decompressed before it is displayed.

During the presentation, the user may use the GUI to perform several functions such as navigating through the individual images, choosing to display full screen or thumbnail images, aborting the current presentation and retrieving a new presentation.

FIGS. 1-5 illustrate specific embodiments of the present invention. Those with skill in the art will recognize that there are other embodiments contemplated that are not illustrated. For example, in another embodiment, a projector may not possess the appropriate printer-driver software in order to perform as a printer. In this embodiment, the user first establishes a connection with a networked computer or server via the input device. The user may use a GUI displayed on a display device operably connected to the projector to maneuver through the download procedure. The user may then download the appropriate printer-driver from the networked computer or server via the network connection.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A computer program product in a computer readable medium, the computer program product comprising:
projector driver computer readable code for converting an application file into a projectable image file for presentation by a projector connected to a network; and
a network interface computer readable code for communicating the projectable image file in the form of a printer file over the network to the projector to thereby facilitate a subsequent presentation of the projectable image file by the projector.

2. The computer program product of claim 1, wherein the application file includes at least one of a text file and a graphics file.

3. The computer program product of claim 1, wherein the projectable image file includes at least one of a .pdf file, a .jpg file, a.gif file, .png file, a .tif file and a .bmp file.

4. The computer program product of claim 1, further comprising:
a graphical user interface computer readable code for displaying a printer listing including the projector to thereby facilitate the communication of the projectable image file in the form of a printer file by the network interface module over the network to the projector.

5. The computer program product of claim 4, wherein said graphical user interface computer readable code further interactively manipulates the printer file.

6. The computer program product of claim 1, wherein the computer readable medium is embodied in a computer.

7. A computer program product in a computer readable medium, the computer program product comprising:
a project driver computer readable code for converting an application file to a projectable image file for presentation by a projector connected to a network; and
a graphical user interface computer readable code for displaying a printer listing including the projector to thereby facilitate a subsequent communication of the projectable image file in the form of a printer file from the computer over a network to the projector.

8. The computer program product of claim 7, wherein the application file includes at least one of a text file and a graphics file.

9. The computer program product of claim 7, wherein the projectable image file includes at least one of a .pdf file, a .jpg file, a.gif file, .png file, a .tif file and a .bmp file.

10. The computer program product of claim 7, wherein said graphical user interface computer readable code further interactively manipulates the printer file.

11. The computer program product of claim 7, wherein the computer readable medium is embodied in a computer.

12. A computer program product in a computer readable medium, the computer program product comprising:
network interface computer readable code for communicating a projectable image file over a network to a projector; and
graphical user interface computer readable code for displaying a file listing including the projectable image file to thereby facilitate a subsequent presentation of the projectable image file by the projector.

13. The computer program product of claim 12, wherein the application file includes at least one of a text file and a graphics file.

14. The computer program product of claim 12, wherein the projectable image file includes at least one of a .pdf file, a .jpg file, a.gif file, .png file, a .tif file and a .bmp file.

15. The computer program product of claim 12,
wherein the computer readable medium is embodied in the projector; and
wherein the network perceives the projector to be a printer.
